(19) United States
(12) Patent Application Publication
(10) Pub. No.: US 2008/0291504 A1
(43) Pub. Date: Nov. 27, 2008

(54) IMAGE OUTPUT SYSTEM AND IMAGE PROCESSING APPARATUS

(76) Inventor: Tomoyuki HONMA, Kizugawa-shi (JP)

Correspondence Address: BIRCH STEWART KOLASCH & BIRCH, PO BOX 747, FALLS CHURCH, VA, 22040-0747, US

(21) Appl. No.: 12/124,312

(22) Filed: May 21, 2008

(30) Foreign Application Priority Data
May 22, 2007 (JP) 2007-135293

(51) Int. Cl. H04N 1/387; G06K 15/00

(52) U.S. Cl. 358/452; 358/453; 358/1.16

(57) ABSTRACT

A client apparatus specifies a particular region in an image to be transmitted and a processing method thereof, and generates processing information. A job is generated based on the image and the processing information, and transmitted to an image processing apparatus. The image processing apparatus transmits the image via facsimile. According to the processing information, processing of erasing a particular image within the particular region is performed. The processing information and the processed image are stored in a storage section. When the image is retransmitted, the image is read from the storage section and edited so that an image of a string such as a date is attached to the particular region, according to the processing information. The edited image is transmitted via facsimile. Thereby, it is possible to prevent leakage of confidential information from an image stored for reuse.

### BACKGROUND OF THE INVENTION

1. Field of the Invention

The present invention relates to an image output system having an image processing apparatus which outputs an inputted image to the outside via facsimile communication or data communication.

2. Description of the Related Art

Generally, in an image processing apparatus which performs facsimile communication, an image generated in a client apparatus such as a personal computer is inputted, and the image is transmitted via facsimile to a specified destination. The transmitted image is erased, and the image is not left in the image processing apparatus. However, if retransmission of this image is desired, the image has to be inputted again.

Consequently, Japanese Patent Laid-Open No. 2002-290658 describes that only a body text in facsimile data including a covering letter and the body text has been stored in a storage section. The retransmission can be easily performed by reusing this body text.

An image stored for the retransmission in the image processing apparatus may include confidential information such as personal information. If the image has been directly stored, the image may be retrieved from the image processing apparatus due to unauthorized use by third parties. Thereby, the confidential information is leaked, which causes a security problem.

In view of the above description, an object of the present invention is to provide an image output system having an image processing apparatus in which, when an image is stored for retransmission, the image can be processed and stored so that confidential information may not be leaked.

### SUMMARY OF THE INVENTION

The present invention is an image output system configured with a client apparatus for generating an image, and an image processing apparatus for outputting the above described image inputted from the client apparatus to the outside, also storing the above described image in a storage section, and outputting the above described stored image again, wherein the image processing apparatus includes an image processing section for processing a particular region in the above described image so that the particular region cannot be discriminated and recognized. The image in which the particular region has been processed is stored in the storage section.

The particular region is a region including an image related to confidential information. The image processing section performs processing such as erasure, filling or replacement with respect to the particular region so that this particular region cannot be recognized. Thereby, it becomes impossible to recognize an original image within the particular region. Since the thus processed image is stored in the storage section, even if this image is retrieved, the confidential information is not leaked.

The image processing apparatus includes an image reprocessing section for editing the particular region when the processed image stored in the storage section is outputted. Then, an edited image is outputted. Since the particular region is edited, the image within the particular region becomes different from the original image. For example, the image reprocessing section edits the particular region so that a new image is attached to the particular region. Therefore, an image not including the confidential information can be outputted.

The client apparatus includes a specification section for specifying the particular region and also specifying a processing method, and outputs processing information on the particular region and the processing method to the image processing apparatus along with the image. The image processing apparatus stores the processing information in the storage section. The specification section detects an image including the confidential information from the image, and sets a region including this image as the particular region. At this time, it is determined what kind of editing is performed with respect to the particular region. For example, the processing method is specified by selecting processing of erasing the image within the particular region, attaching a new image, transforming the image or the like.

The specification section detects a region in which a determined pattern image exists, and specifies the region as the particular region. Thereby, the particular region including the same image as the pattern image can be detected, and the particular region can be automatically specified. At this time, the processing method can also be automatically specified if the processing method has been determined with respect to the pattern image.

The image reprocessing section edits the particular region according to the specified processing method, with respect to the image in which the particular region has been processed. In other words, the image reprocessing section attaches a new image to the particular region or transforms the image. If the processing method is erasing, the image reprocessing section does nothing with respect to the particular region.

When the image is outputted again, the image reprocessing section attaches an image required for outputting the image again, to the particular region. Information required when the image is outputted again can include, for example, a date, a destination, a transmitter and the like. The image reprocessing section generates an image representing this information and attaches the image to the particular region.

The client apparatus includes a display section for displaying the image, and the specification section specifies the particular region in the displayed image and determines a type of the particular region. Thereby, a user can see a screen to check the particular region. Then, since the user can discriminate what the image within the particular region represents, the user can determine the type of the particular region.

The image reprocessing section edits the particular region according to the processing method depending on the type of the particular region. The user can edit the particular region so that an image of the same type as the original image is attached, by recognizing the type of the particular region.

The present invention is an image processing apparatus for outputting an inputted image to the outside, also storing the above described image in a storage section, and outputting the above described stored image again, including an image processing section for processing a particular region in the inputted image, and an image reprocessing section for editing the particular region when the image stored in the storage section is outputted, wherein the image processed by the image processing section is stored in the storage section, and an image read from the storage section and edited by the image reprocessing section is outputted. Thereby, the particular region can be processed and edited by the image processing apparatus by itself.

Processing information on the particular region and a processing method is stored in the storage section, and the image reprocessing section edits the particular region according to the processing information. For example, the image processing section performs processing of erasing an image in the particular region, and the image reprocessing section attaches a new image to the particular region. It should be noted that the specification of the particular region and the specification of the processing method are also performed in the image processing apparatus.

According to the present invention, in the case where the image outputted from the image processing apparatus is stored and reused, even if this image is the image including the confidential information, the image to be stored or the image to be outputted again does not include the confidential information. Therefore, if the image is reused, it is possible to prevent the leakage of the confidential information and realize a high security system and a high security image processing apparatus.

### BRIEF DESCRIPTION OF THE DRAWINGS

FIG. 1 is a diagram showing a schematic configuration of an image output system of the present invention;

FIG. 2 is a diagram showing a sequence when an image transmitted via facsimile is retransmitted;

FIG. 3 is a diagram showing a destination input screen;

FIG. 4 is a diagram showing an input screen for specifying a particular region;

FIG. 5 is a diagram showing the input screen for specifying the particular region of another form;

FIG. 6(A) is a diagram showing a registered image pattern example;

FIG. 6(B) is a diagram showing the input screen for specifying the particular region of another form;

FIG. 7 is a diagram showing an example of data contents of a job including processing information;

FIG. 8 is a diagram showing images before and after being processed;

FIG. 9 is a diagram showing an example of a region information table generated from a received job;

FIG. 10 is a diagram showing storage of the processed image as an image file in a storage section;

FIG. 11 is a diagram showing a date input screen and an image attached with a date; and

FIG. 12 is a diagram showing the destination input screen when the retransmission is performed.

### DETAILED DESCRIPTION OF THE PREFERRED EMBODIMENT

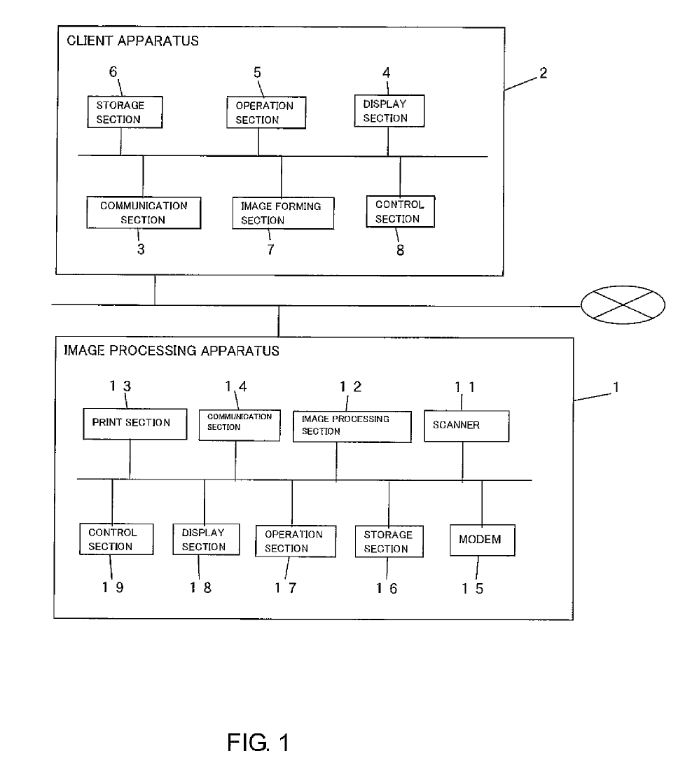

FIG. 1 shows an image output system of this embodiment. The image output system is configured by communicably connecting an image processing apparatus 1 and a client apparatus 2 such as a personal computer, through a network such as a LAN. Multiple image processing apparatuses 1 and multiple client apparatuses 2 are connected to the network. Moreover, the network is connected to the Internet.

The client apparatus 2 is a general computer provided with a communication section 3, a display section 4, an operation section 5, a storage section 6, an image forming section 7 and a control section 8. The control section 8 starts an application such as word processor software in response to an input operation from the operation section 5 and generates data such as a document. The storage section 6 stores the data. The image forming section 7 converts the data into an image with a printer driver and generates a job. The communication section 3 transmits the job to the image processing apparatus 1. In other words, the client apparatus 2 generates the image to be outputted to the image processing apparatus 1.

The image processing apparatus 1 is an MFP which executes respective processes of copy, print, scan, facsimile communication and document filing. The image processing apparatus 1 is provided with a scanner 11, an image processing section 12, a print section 13, a communication section 14, a modem 15, a storage section 16, an operation section 17, a display section 18 and a control section 19. The scanner 11 reads a document and inputs an image. The image processing section 12 performs a predetermined process with respect to the image. The print section 13 prints the image on a recording sheet. The communication section 14 communicates with the client apparatus 2 or another image processing apparatus 1 through the network to transmit and receive the data. The modem 15 is connected to a telephone line and performs the facsimile communication. The storage section 16 stores the image or various information. The operation section 17 accepts an input operation, and the display section 18 displays an operation screen or various messages. The control section 19 controls the respective sections and performs instructed processings.

This image processing apparatus 1 stores the image inputted from the scanner 11 or the communication section 14 in the storage section 16, and outputs the image to the outside via the printing or the communication. Then, the stored image is read and outputted to the outside again via the printing or the communication.

For example, if the client apparatus 2 performs PC-FAX for performing the facsimile communication through the image processing apparatus 1, the client apparatus 2 outputs the generated image to the image processing apparatus 1. In addition, it is assumed that the printer driver has a PC-FAX function. The image processing apparatus 1 inputs the image and transmits the image to a specified destination via facsimile. Moreover, the image processing apparatus 1 stores the inputted image in the storage section 16. Subsequently, in response to instruction from the client apparatus 2 or input from the operation section 17, the image is read from the storage section 16 and transmitted to the specified destination via facsimile.

Incidentally, the generated image may include confidential information such as the destination or a transmitter. If such an image is directly stored or the image is directly outputted again, the confidential information is leaked. Consequently, in the image processing apparatus 1, a region in which an image including the confidential information or a specified image of a photograph, a diagram, a graph, a table or the like (which is referred to as “particular image”) exists is regarded as “particular region”, and the particular region in the image is decided. Then, the particular region is processed so that the particular region cannot be discriminated, and the processed image is stored. Moreover, when the stored image is outputted, the particular region is edited and the edited image is outputted. Thereby, in the stored image or the outputted image, the particular image can be in an unrecognizable state with respect to third parties.

The control section 8 in the client apparatus 2 specifies the particular region and also specifies a method of processing the image. Then, processing information on the particular region and the processing method is generated. The processing information is outputted to the image processing apparatus 1 along with the image. In other words, the control section 8 functions as a specification section for specifying the particular region and also specifying the processing method. The processing method can include erasing the particular image, filling the particular image, editing the particular image such as enlargement, reduction or decoration, replacement for changing the particular image into an unrelated image and the like. According to such a processing method, it can be impossible to discriminate an original particular image when the image is outputted again.

In the image processing apparatus 1, the image processing section 12 decides the particular region based on the processing information, and processes the image included in this region. Moreover, the image processing section 12 edits the particular region when the output is performed. In other words, the image processing section 12 functions as an image reprocessing section for editing the particular region.

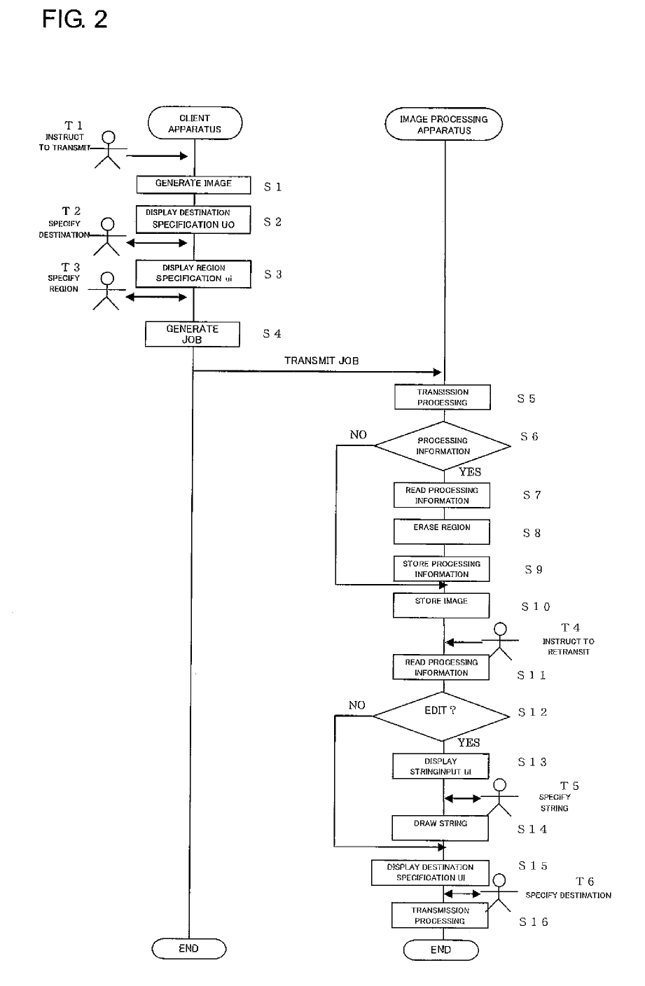

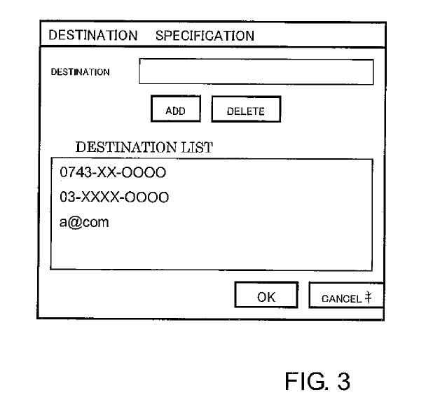

In the image output system configured as described above, a procedure of performing the facsimile communication by the PC-FAX will be described according to FIG. 2. In the client apparatus 2, a user first generates the image which the user wants to transmit (S1). Then, the user operates to execute the PC-FAX (T1). The control section 8 starts the printer driver, and displays a user interface (UI) screen for specifying the destination as shown in FIG. 3 on the display section 4 (S2). The user inputs any of a FAX number, an email address and an IP address to specify the destination (T2). If the inputted destination is added, an ADD button is operated. The added destination is stored in the storage section 6 and displayed in a destination list.

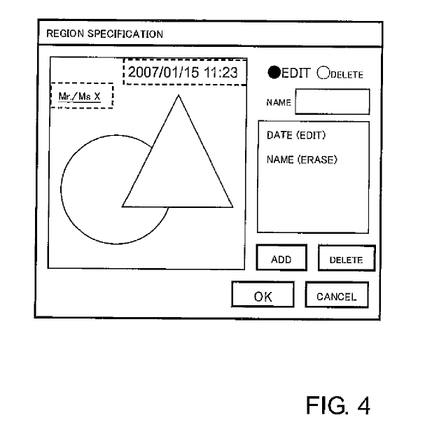

Next, the control section 8 displays a user interface screen for specifying the region as shown in FIG. 4 on the display section 4 (S3). On this screen, the generated image is displayed. The user selects the particular region on the screen and manually specifies the particular region. Then, the user specifies the process and a title with respect to the particular region (T3). Here, two processes of editing and erasure can be selected as the processing. The title is attached for identifying the specified particular region. For example, if the particular image is an image of a string representing a date and time, “DATE” is set as the title, and if the particular image is an image of a string representing the destination, “NAME” is set as the title. The particular region is not limited to one and multiple particular regions can be specified.

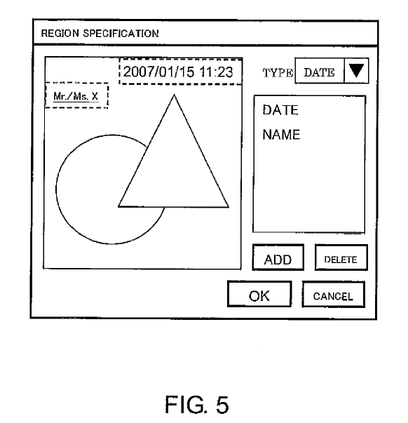

As another form related to the specification of the particular region, the specification of the processing method is automatically performed. A user interface screen for specifying the region as shown in FIG. 5 is displayed on the display section 4. The user selects the particular region on the screen and selects a type of the particular region. Multiple types of the particular region have been previously set, and the user selects an appropriate type from the multiple types. For example, “DATE” and “NAME” have been set as the types. Moreover, the processing method with respect to the type has also been previously set. The editing is set with respect to “DATE”, and the erasure is set with respect to the “NAME”. Therefore, when the user selects the type with respect to the particular region, the control section 8 automatically specifies the processing method. Thereby, the user does not have to go to the trouble of inputting. It should be noted that the editing may be set as the processing method with respect to “NAME”.

In FIGS. 4 and 5, the particular region is a region surrounded by a dotted line. The user moves a cursor displayed on the screen to select a desired region. For example, a particular image of a string representing a date and time of “2007/01/15 11:23” is selected. In the case of manual specification, “EDIT” on the screen is specified, and “DATE” is inputted as the title of the particular region. Then, “DATE (EDIT)” is displayed on the screen. In the case of automatic specification, when “DATE” is specified, “DATE” is displayed on the screen. Then, the editing is automatically set as the processing method. Moreover, similarly, a particular image of a string representing a name of “Mr./Ms. X” is selected. In the case of the manual specification, “ERASE” on the screen is specified, and “NAME” is inputted. “NAME (ERASE)” is displayed on the screen. In the case of the automatic specification, when “NAME” is specified, “NAME” is displayed on the screen, and the erasure is automatically set as the processing method.

Moreover, as another form related to the specification of the particular region, the particular region and the processing method are automatically specified. The control section 8 searches the particular image in the image to detect the region in which the particular image exists, specifies the region as the particular region, and also specifies the processing method depending on the type of the particular region.

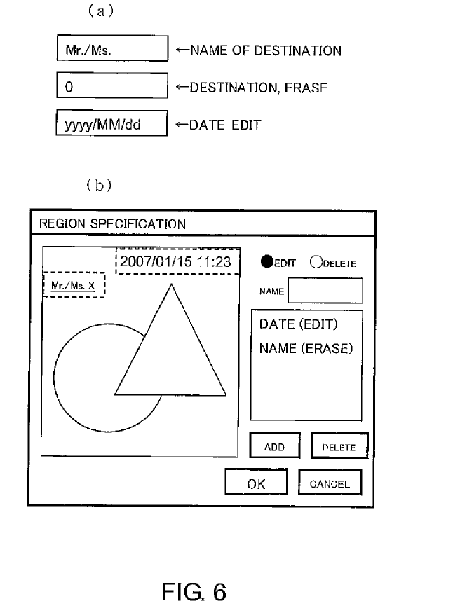

In other words, the particular image is detected based on a determined image pattern. As shown in FIG. 6(A), an image pattern including characters such as “Mr./Ms.” or “Esq.” at the end of the string is registered as “NAME”, and the processing method for this image pattern is registered as the erasure. An image pattern of a string starting with “0”, such as the FAX number, is also registered as “DESTINATION”, and the processing method for this image pattern is registered as the erasure. These image patterns are regarded as the destination.

The image patterns such as “yyyy/MM/dd” and “Heisei Era yy Year MM Month dd Day” are registered as “DATE”, and the editing is registered as the processing method. It should be noted that, the image pattern is not limited to the above described image patterns, and the image pattern may be the number of digits of a string consisting of numbers, a combination of a number and a hyphen, a string which independently exists like the destination, or the like.

A user interface screen for specifying the region as shown in FIG. 6(B) is displayed on the display section 4. At this time, the control section 8 searches whether or not the particular image exists in the image based on pattern matching with the image pattern. When the particular image matching the image pattern is detected, a region including a string configured with the particular image is identified and specified as the particular region. Simultaneously, the processing method is specified based on the matched image pattern. Multiple particular regions which have been automatically specified in this way are surrounded by the dotted lines and displayed on the screen, and the processing methods with respect to the respective particular regions are displayed. Here, the user can check the specified particular regions based on the displayed screen. Then, the user can add or delete the particular region to change the specification.

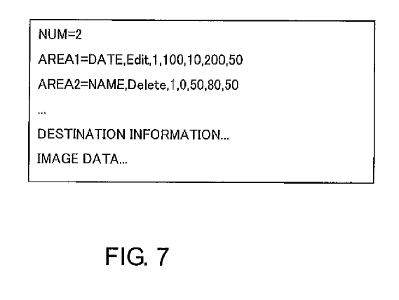

After the particular region and the processing method have been specified, the control section 8 generates the processing information on the particular region and the processing method. As shown in FIG. 7, the processing information includes the number of the particular regions, the types, the processing methods, positions and sizes. The processing information is attached to header information along with the specified destination. The image forming section 7 generates the job based on this header information and image data, and transmits the job to the image processing apparatus 1 through the communication section 3 (S4).

The image processing apparatus 1 receives the job through the communication section 14. The control section 19 temporarily stores an image of the job in the storage section 16. The image processing section 12 expands the image in a memory, and converts the image into a facsimile transmission data format. The control section 19 transmits the image via facsimile to the destination specified through the modem 15 (S5). In the case of Internet FAX, the control section 19 attaches the image to an email and transmits the email to another client apparatus 2 through the communication section 14.

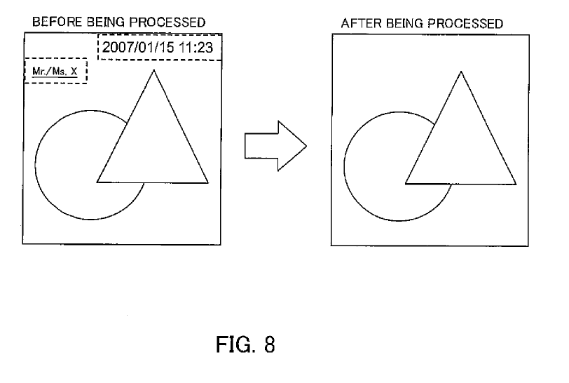

Moreover, when the control section 19 receives the job, the control section 19 checks whether or not the header information includes the processing information (S6). When the processing information is included, the control section 19 reads the processing information (S7), and instructs the image processing section 12 to perform the processing. The image processing section 12 decides the particular region, and as shown in FIG. 8, performs the processing of erasing the particular image within the particular region (S8). When there are multiple particular regions, the particular images within all particular regions are erased.

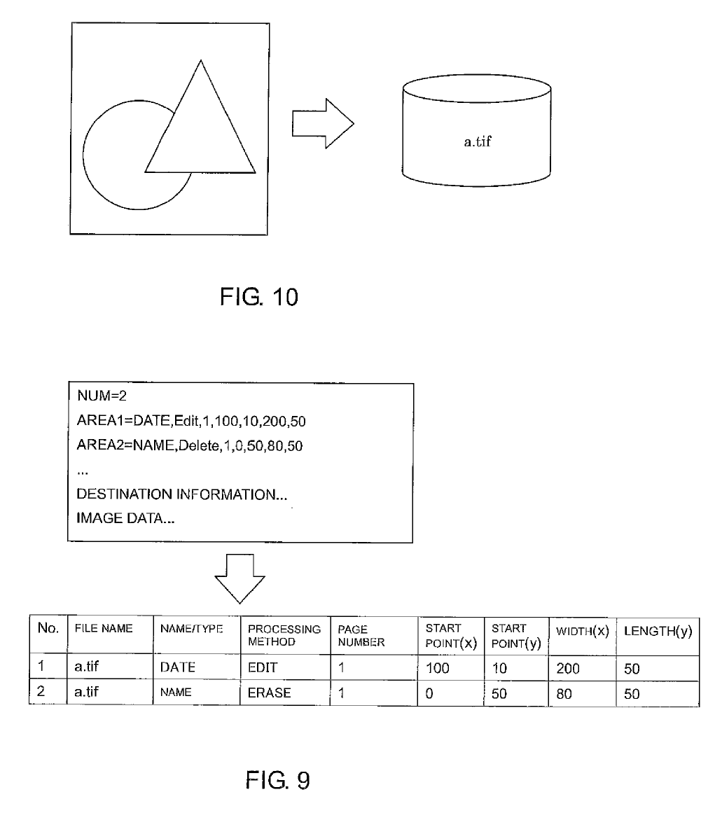

As shown in FIG. 9, the control section 19 writes the processing information in a region information table in the storage section 16 to store the processing information (S9). Also, simultaneously, as shown in FIG. 10, the processed image is stored as an image file in the storage section 16 (S10). In the region information table, the processing information is associated with an image file having a file name “a.tif” and managed. It should be noted that if the processing information is not included, the control section 19 stores the transmitted image in the storage section 16.

Subsequently, in response to the user's operation, the client apparatus 2 specifies the stored image and provides retransmission instruction. Alternatively, the user operates the operation section 17 in the image processing apparatus 1 to specify the stored image and provides the retransmission instruction (T4). The control section 19 reads the processing information from the storage section 16 (S1).

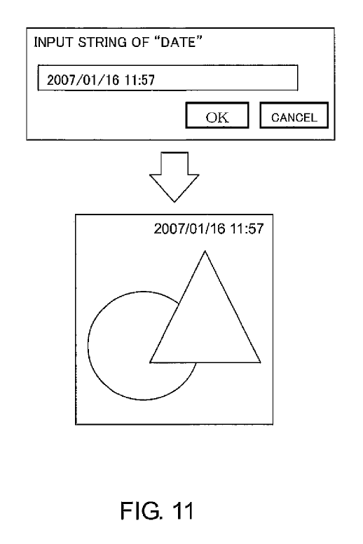

With respect to the specified image, it there is processing information in which the processing method is editing (S12), the control section 19 displays an input user interface screen as shown in FIG. 11 (S13). Since the type of the particular region is “DATE”, a guide screen for inputting a date is displayed. The user can recognize what kind of image the particular image is, based on the type of the particular region. Therefore, an image such as an extraneous string can be prevented from being attached to the particular region.

When the user inputs the date (T5) the image processing section 12 attaches an image of a string depending on the date, within the particular region. The control section 19 displays the edited image on the display section 18 (S14). Here, instead of inputting the date by the user, the control section 19 may automatically input a current date. When the editing process with respect to all particular regions has been completed, the image processing section 12 temporarily stores the edited image in the storage section 16.

With respect to the specified image, if there is no processing information in which processing method is editing, or in the case of the image without the processing information, the control section 19 directly displays the stored image.

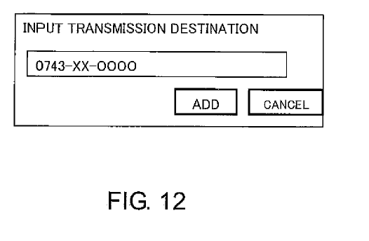

Subsequently, the control section 19 displays a user interface screen for specifying the destination as shown in FIG. 12 on the display section 18 (S15). The user inputs a desired destination (T6). In the case of also transmitting to another destination, the destination is additionally inputted. Moreover, in the case of the retransmission instruction from the client apparatus 2, the client apparatus 2 transmits inputted destination information. The control section 19 sets the destination according to this destination information.

Then, the image processing section 12 expands the image in the memory, and converts the image into the facsimile transmission data format. The control section 19 transmits the image via facsimile to the specified destination through the modem 15 (S16).

Thereby, when the image is retransmitted, an image not including the confidential information such as personal information can be transmitted. Moreover, also with respect to the stored image, since an image in which the confidential information has been erased is stored, even if the third parties access and retrieve the image in an unauthorized manner, the confidential information is not leaked.

In the above description, the case of performing the PC-FAX has been described. In addition to this, as the image output in the image processing apparatus 1, in the case of printing, the image inputted from the client apparatus 2 is printed on the recording sheet and thereby outputted to the outside. In the case of scanning, the image read and inputted by the scanner 11 is stored in the storage section 16. The stored image is transmitted to the client apparatus 2 or another image processing apparatus 1, and thereby outputted to the outside. In the case of document filing, the image read by the scanner 11 or the image inputted from the client apparatus 2 is stored in the storage section 16. Then, the stored image is printed or data thereof is transmitted, and thereby outputted to the outside.

In these processes, the image processing apparatus 1 stores the image in the storage section 16. Then, this image is outputted again. Consequently, also in the case of performing the above described processing, similarly, the particular region in the image is processed and the processed image is stored. Then, the particular region is edited and the edited image is outputted. Therefore, if the image processing apparatus 1 has processed the image including the confidential information and subsequently reuses this image, it is possible to prevent the leakage of the confidential information since the confidential information has been deleted from the image.

It should be noted that the present invention is not limited to the above described embodiment, and of course, it is possible to add many modifications and alterations to the above described embodiment within the range of the present invention. The particular region may be processed and edited by the image processing apparatus by itself, which is applicable to the case of scanning and storing the image, and the case of transmitting the scanned and inputted image via facsimile and storing the image, in the image processing apparatus. In other words, the image processing section in the image processing apparatus processes the particular region in the inputted image. The processed image is stored in the storage section. Then, when the image stored in the storage section is outputted, the image processing section edits the particular region. The edited image is outputted. The control section specifies the particular region and also specifies the processing method. The function of the image processing section and the specification function of the control section are the same as the above described embodiment.

Moreover, the storage section for storing the image is not limited to the storage section mounted in the image processing apparatus, and may be an external storage section. In other words, a file server connected to the image processing apparatus through a network may be the storage section. The image processing apparatus transmits the inputted image to the storage section, and the storage section stores the received image. When the image is outputted, the storage section transmits the image to the image processing apparatus, and the image processing apparatus outputs the received image.

What is claimed is:

1. An image output system configured with a client apparatus for generating an image and an image processing apparatus for outputting the image inputted from the client apparatus to the outside, also storing the image in a storage section, and outputting the stored image again,
wherein the image processing apparatus comprises an image processing section for processing a particular region in the image so that the particular region cannot be discriminated, and the image in which the particular region has been processed is stored in the storage section.

2. The image output system according to claim 1, wherein the image processing apparatus comprises an image reprocessing section for editing the particular region, and outputs an edited image when the image stored in the storage section is outputted.

3. The image output system according to claim 2, wherein the image processing section performs processing of erasing an image in the particular region, and the image reprocessing section attaches a new image to the particular region.

4. The image output system according to claim 2, wherein the client apparatus comprises a specification section for specifying the particular region and also specifying a processing method, and outputs processing information on the particular region and the processing method to the image processing apparatus along with the image, and the image processing apparatus stores the processing information in the storage section.

5. The image output system according to claim 4, wherein the specification section detects a region in which a determined pattern image exists, and specifies the region as the particular region.

6. The image output system according to claim 4, wherein the image reprocessing section edits the particular region, according to the specified processing method, with respect to the image in which the particular region has been processed.

7. The image output system according to claim 4, wherein when the image is outputted again, the image reprocessing section attaches an image required for outputting the image again to the particular region.

8. The image output system according to claim 4, wherein the client apparatus comprises a display section for displaying the image, and the specification section specifies the particular region in the displayed image and determines a type of the particular region.

9. The image output system according to claim 8, wherein the image reprocessing section edits the particular region according to the processing method depending on the type of the particular region.

10. An image processing apparatus for outputting an inputted image to the outside, also storing the image in a storage section, and outputting the stored image again, comprising:
an image processing section for processing a particular region in the inputted image so that the particular region cannot be discriminated; and
an image reprocessing section for editing the particular region when the image stored in the storage section is outputted,
wherein the image processed by the image processing section is stored in the storage section, and an image read from the storage section and edited by the image reprocessing section is outputted.

11. The image processing apparatus according to claim 10, wherein processing information on the particular region and a processing method is stored in the storage section, and the image reprocessing section edits the particular region according to the processing information.

12. The image processing apparatus according to claim 11, wherein the image processing section performs processing of erasing an image in the particular region, and the image reprocessing section attaches a new image to the particular region.
